(19) United States
(12) Patent Application Publication
(10) Pub. No.: US 2017/0181819 A1
(43) Pub. Date: Jun. 29, 2017

(54) POP-A-DENTURE

(71) Applicant: Lydia Christian, Mansfield, TX (US)

(72) Inventor: Lydia Christian, Mansfield, TX (US)

(21) Appl. No.: 14/980,866

(22) Filed: Dec. 28, 2015

(51) Int. Cl. A61C 13/24; A61C 13/00; A61C 13/08

(52) U.S. Cl. CPC A61C 13/24; A61C 13/082; A61C 13/0024

(57) ABSTRACT

The present invention is a pre-made set of temporary dentures with various sizes of an elastomeric material which provides a satisfactory physical appearance.

### TECHNICAL FIELD OF THE INVENTION

The present invention relates to a pre-made disposable denture appliance for temporary use.

### BACKGROUND OF THE INVENTION

Dentures, or false teeth, are typically made of a colored plastic to appear as gum tissue and supports a full set of plastic or porcelain teeth. Dentures are retained by a seal with the user's gums, or by attachment to dental implants or the user's teeth which do not need replacement.

Many issued patents and applications for patent have been filed for temporary dentures, but they are all designed to be used for days and weeks, earnestly used during that time to speak, chew food, and generally have a normal life.

Because the temporary dentures available in the market still require a certain amount of customization in order to be used for days, they remain expensive and time-consuming to fit, and still take a few hours to create, taking at least a few hours to create.

However, even in clinics where dentures can be created in a few hours, patients have found that they enjoy leaving a dental clinic while their dentures are being produced for those few hours. Unfortunately, the market has not supplied ready-to-wear dentures that are suitable for this short time period, leaving dental patients to either stay in the dental clinic, or go somewhere that they will not feel conspicuous if they are required to open their mouths.

The dental industry has not created or yet developed a denture product designed for use of just a few hours, because dentists recognize that such a denture would be uncomfortable. Yet patients, if given a choice, would prefer to have some sort of denture, even if it was not as comfortable or esthetically pleasing as their permanent dentures will appear, just so they could have the freedom to move around, visit a mall and do some shopping, or go to a movie while a clinic is working on the more robust permanent or longer term fitted dentures.

### SUMMARY OF THE INVENTION

The present invention is an elastomeric set of temporary dentures that patients can use without any significant fitting time, so they can appear in public without fear of embarrassment and without waiting for personally fitted dentures to be created.

### BRIEF DESCRIPTION OF THE DRAWINGS

For a better understanding of the disclosure, and to show by way of example how the same may be carried into effect, reference is now made to the detailed description along with the accompanying figures in which corresponding numerals in the different figures refer to corresponding parts. Though the following descriptions refer to “the invention” or “the dentures”, it should be understood that the drawings provided show merely one embodiment of the invention, and is not intended to encompass the entirely of the invention and all embodiments, but an example of one construction of the invention only.

FIGS. 1A, 1B, and 1C show an orthogonal view of the temporary dentures of varying sizes.

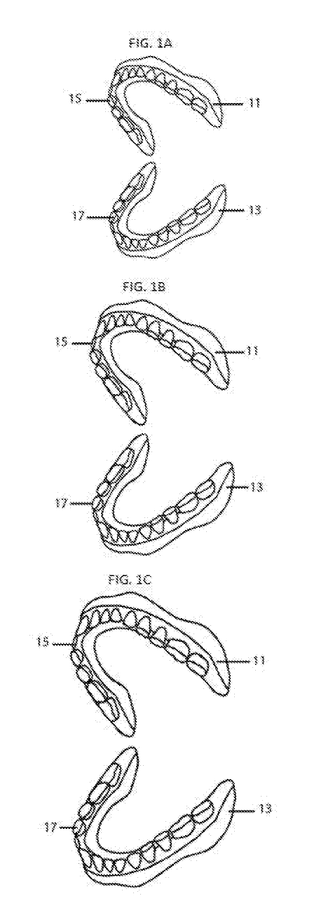

FIGS. 2A, 2B and 2C show a frontal view of the bottom part of the temporary dentures of varying sizes.

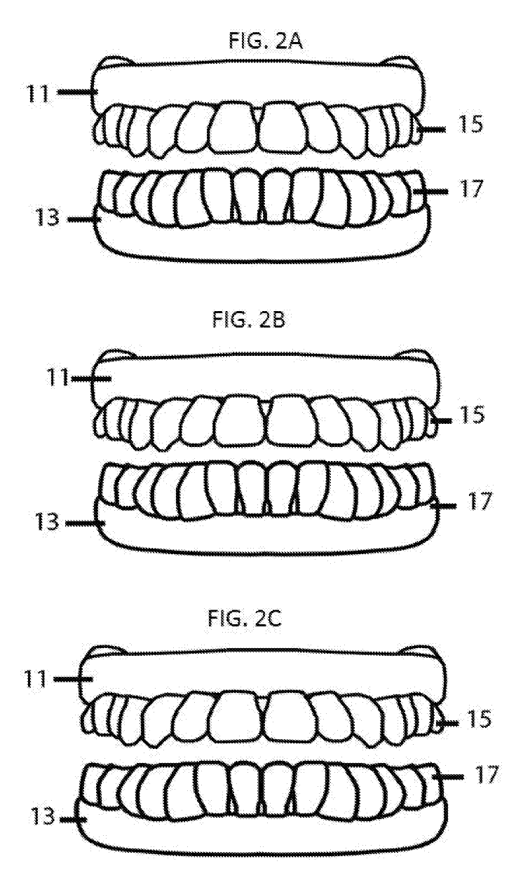

FIGS. 3A, 3B, and 3C, show a rear view of the temporary dentures of varying sizes.

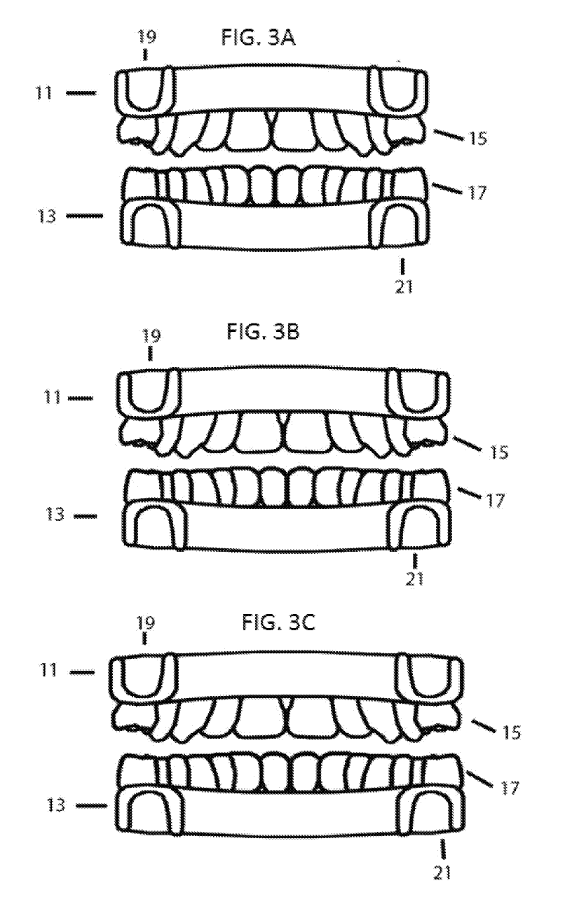

FIGS. 4A, 4B and 4C, show a rear orthogonal view of the temporary dentures of varying sizes.

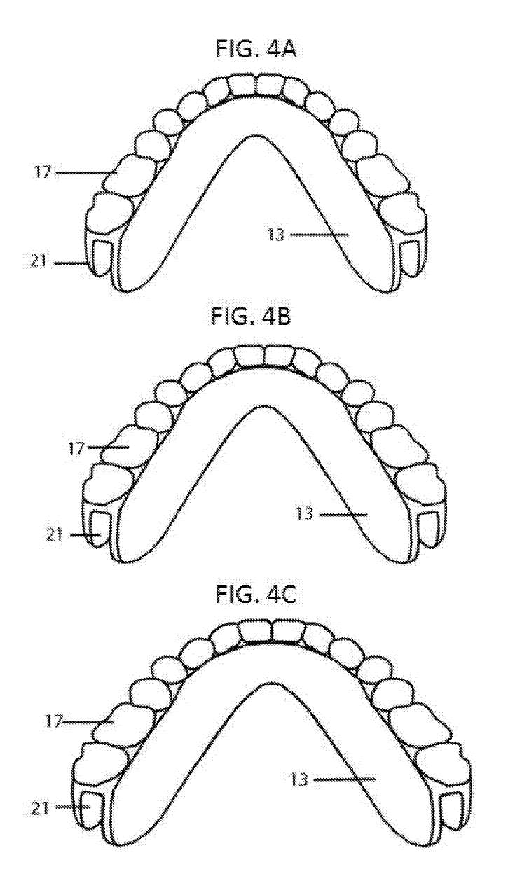

FIG. 5 shows a right side view of the temporary dentures.

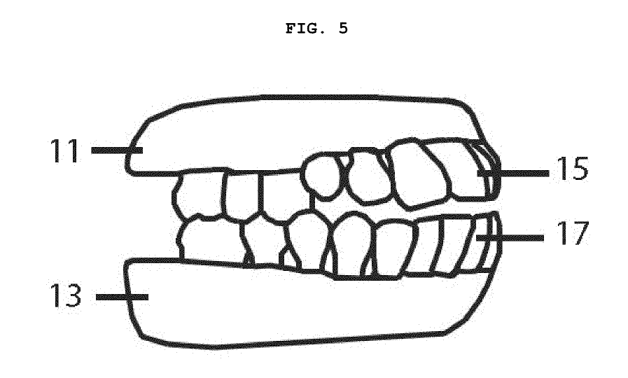

FIG. 6 shows a left side view of the temporary dentures.

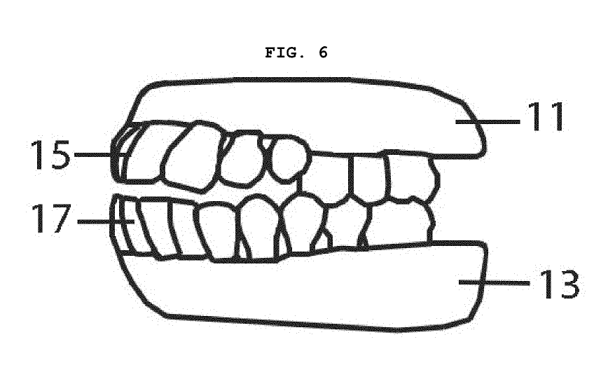

FIG. 7 shows an optional mounting of the Bottom Denture 13 onto Dental Implants 25.

### DETAILED DESCRIPTION OF THE INVENTION

While the making and using of various embodiments of the present disclosure are discussed in detail below, it should be appreciated that the present disclosure provides many applicable inventive concepts, which can be embodied in a wide variety of specific contexts. The disclosure is primarily described and illustrated hereinafter in conjunction with various embodiments of the presently-described systems and methods. The specific embodiments discussed herein are, however, merely illustrative of specific ways to make and use the disclosure and do not limit the scope of the disclosure.

As shown in the figures, the invention comprises a set of estomeric temporary dentures, also known as dental prosthetics, dental appliances, or false teeth. The invention is intended to be offered in three different sizes to a patient.

This application shows three different embodiments, which differ only in their size, with the intention that most people will be able to use one of the three sizes and a dental provider can offer its patients whichever of the three sizes fits most closely.

Because the invention is made of an elastomeric material not designed for chewing or permanent use, a user can place it in his mouth, keeping it in place by pressure of pressing the invention in place on both the simply keeping his mouth shut and creating a suction-grip, kept in place with one of the many denture adhesive products already available, or pressed onto a user's dental implants, when present.

Dentures are common and known. For purposes of this application and as reflected in the drawings, each pair of dentures has a Top Denture 11 and Top Hollow 19 which fits on the upper jaw of a user, and a Bottom Denture 13 and Bottom Hollow 21 which fits on the user's lower jaw.

The Dentures 11 13 are constructed with a typical pink color of human gums.

The Bottom Denture 13 is mounted on the user's teeth and gums of user's bottom jaw. Similarly, the Top Denture 11 is mounted on the teeth and gums of the user's upper jaw.

As the dentures are constructed of an elastomeric material which has substantial elasticity, a user may be able to mount the Dentures 11 13 without a dental adhesive. However, a user may also be desire to use the invention with a dental adhesive, many of which are known in the art and available from many sources, e.g. Fixodent, Poligrip.

The ability to use the invention with a dental adhesive may depend on the number of mounting points that a user has, i.e., teeth which are in good health gums and any artificial mounting points installed, as well as the shape of the mouth.

To use the invention, a user may be able to simply place the Dentures 11 13 onto the user's upper and lower teeth, press against the user's gums, inserting the Hollows 19 21 against the gums and teeth of the upper and lower jaws, respectively.

Because the Dentures 11 13 are elastomeric, it is intended that a user can create a suction grip between them and the user's gums which is sufficient to hold the Dentures 11 13 in place. If the suction is not possible due to insufficient gum and teeth structure, the user then uses dental adhesive to create the bond.

A primary advantage of the invention is that a user can select a set of Dentures 11 13 which can fit the user's mouth and effect a “normal” appearance, as a set of Top Teeth 15 and Bottom Teeth 17 are mounted on the Top Denture 11 and the Bottom Denture 13, respectively, and because the Teeth 15 17 are constructed with a typical off-white color of healthy teeth. The overall esthetic effect is to create the appearance in the user's mouth of a healthy set of teeth and gums to the casual view of a third party.

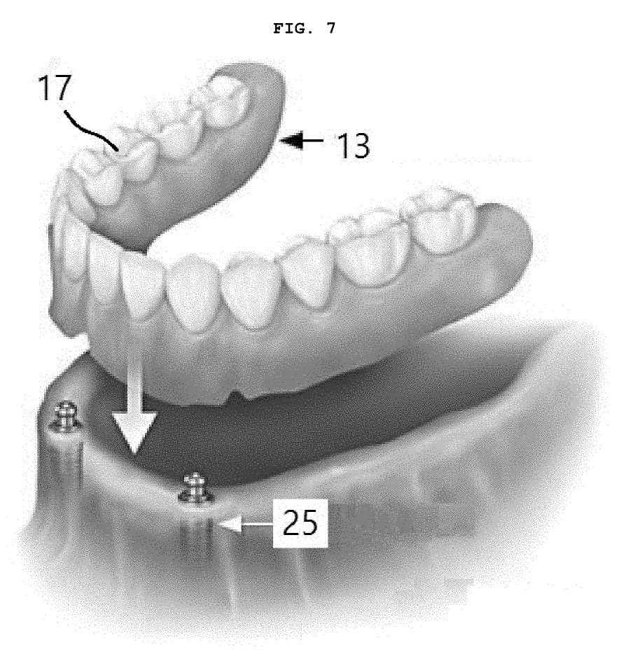

Because the Dentures 11 13 are elastomeric, a dental patient who has installed dental implants (which are known in the art) can push the tip of the implant into the elastomeric material and achieve an excellent mounting for the invention, as shown in FIG. 7, even when no mounting hole has been preconstructed in the Dentures 11 13.

The invention disclosed differs from other temporary dentures in that these dentures do not attempt to fit perfectly or be able to be worn while chewing. The goal is to be able to function in a public setting without embarrassment for a short time—to be able to smile, laugh, and speak.

Because the goals do not include chewing hard substances, the entire invention can be created with the soft elastomer (lower durometer) than typical dentures, which are constructed to allow a user to chew his food.

This difference also allows a user to be able to select from a small number of standard sizes, one of which will function for a short time without undo discomfort to the user, and at very low cost, potentially purchasing these devices in an over-the-counter setting.

While the inventor suggests that a set of three dentures will be sufficient to provide the range of jaw and teeth sizes, the invention is not limited to a three-denture pair set. In addition, because the Dentures 11 13 are made of elastomeric material and could be purchased in an over-the-counter setting, a user could cut away excess material or make modifications that he might find useful.

Legend:

11 - Top Denture
13 - Bottom Denture
15 - Top Teeth
17 - Bottom Teeth
19 - Top Hollow
21 - Bottom Hollow
23 - Optional Glue
25 - Dental Implant

The inventor claims:

1. Dentures, comprising:
a. elastomeric portion resembling human gums;
b. elastomeric portion resembling human teeth;
c. a hollowed portion of the aforementioned gums allowing a user's teeth and gums to fit within; and,
d. said dentures constructed without metal;
e. said dentures constructed without any rigid material;
f. said dentures constructed without a hard liner.

2. A pair of dentures as disclosed in claim one, further limited such that one of the pair of dentures fits a human's upper jaw, and the other of the pair fits a human's lower jaw.

3. A set of dentures as disclosed in claim one that includes multiple sizes, allowing a user to select a size which will fit over his teeth and gums.

4. A method of providing temporary dentures, including:
a. Forming dentures only from an elastomeric material to resemble the teeth and gums of a human upper jaw, such dentures constructed without metal or other rigid materials;
b. Forming dentures from an elastomeric material to resemble the teeth and gums of a human lower jaw;
c. Coloring the upper and lower jaw dentures so the gum and teeth portions of the dentures appear as healthy gums and teeth;
d. Providing an upper jaw denture and a lower jaw denture to a dental patient;
e. Installing the dentures onto their respective jaw.

5. The method of claim 4, with the additional step of
a. creating multiple sizes of dentures,
b. selecting an upper jaw from the various sizes of dentures available; and
c. selecting an lower jaw from the various sizes of dentures available.

6. The method of claim 4, with the additional disclosure of installing the dentures by pressing them onto the user's gums and teeth so that the dentures are held in place by a suction grip between the user's natural gums and the dentures.

7. The method of claim 4, with the additional step of removing additional material from the hollow of the denture's mounting space, to allow a more comfortable fit.

8. The method of claim 4, with the additional disclosure of installing the dentures by using dental adhesive.

9. The method of claim 4, with the additional disclosure of installing the dentures by pressing them onto a dental implant.
